(19) United States
(12) Patent Application Publication
(10) Pub. No.: US 2012/0236116 A1
(43) Pub. Date: Sep. 20, 2012

(54) DECODER, PROJECTION DEVICE, AND IMAGE PROCESSING METHOD

(75) Inventors: Yau Wing Chung, New Taipei City (TW); Yi-Chun Lu, New Taipei City (TW)

(73) Assignee: OPTOMA CORPORATION, New Taipei City (TW)

(21) Appl. No.: 13/421,823

(22) Filed: Mar. 15, 2012

(30) Foreign Application Priority Data
Mar. 18, 2011 (TW) 100109385

(51) Int. Cl. H04N 13/00

(52) U.S. Cl. 348/43; 348/E13.062

(57) ABSTRACT

A decoder, a projection device, and an image processing method are provided. The decoder has a decoding circuit and a buffer coupled to the decoding circuit. The decoding circuit receives a three-dimensional video signal and a control signal and decodes the three-dimensional video signal to generate first image data and second image data. The buffer temporarily stores at least one of the first image data and the second image data. The decoding circuit adjusts an output time difference between outputting the first image data and outputting the second image data according to the control signal.

### CROSS-REFERENCE TO RELATED APPLICATION

This application claims the priority benefit of Taiwan application serial no. 100109385, filed on Mar. 18, 2011. The entirety of the above-mentioned patent application is hereby incorporated by reference herein and made a part of this specification.

### BACKGROUND OF THE INVENTION

1. Field of the Invention

The invention relates to a decoding technique, an image process device, and an image processing method, and in particular, to a decoder, projection device, and an image process method capable of processing three-dimensional video signals.

2. Description of Related Art

In recent years, due to continuous improvement of calculation ability of circuits, three-dimensional projection technique is gradually matured, and the manufacture cost of related hardware is gradually decreased accordingly, such that the three-dimensional technique is acceptable by more and more customers. According to the conventional three-dimensional projection technique, two projectors are used to project two projected images. The user may see a stereoscopic image by wearing three-dimensional glasses having two polarizing units.

Please refer to FIG. 1. The projection system 100 has a first projector 110 and a second projector 120 for processing a three-dimensional video signal S_{IN} to respectively project a first projected image IMG1 and a second projected image IMG2 on the screen 130. When the eyes of the user respectively view the first projected image IMG1 and the second projected image IMG2 through two polarizing units having different polarization characteristics, a stereoscopic image would be seen. However, when the first projected image IMG1 and the second projected image IMG2 are not simultaneously projected, the first projected image IMG1 and the second projected image IMG2 saw by the user are not harmony, thereby resulting in visional discomfort.

To be more specifically, please refer to FIG. 2 and FIG. 3. The first projected image IMG1 has a plurality of projected frames a1 to k1, and the second projected image IMG2 has a plurality of projected frames a2 to k2. The projected frames a1 to k1 and the projected frames a2 to k2 are sequentially illustrated in FIGS. 2 and 3 from left to right according to the sequence of projecting the projected frames a1 to k1 and a2 to k2 on the screen. The projected frame a1 is corresponded to the projected frame a2, the projected frame b1 is corresponded to the projected frame b2, the projected frame c1 is corresponded to the projected frame c2, and so forth. In an identical condition, the projected frames a1 and a2 are projected on the screen 130 simultaneously, the projected frames b1 and b2 are projected on the screen 130 simultaneously, the projected frames c1 and c2 are projected on the screen 130 simultaneously, . . . , and the projected frames k1 and k2 are projected on the screen 130 simultaneously. Thus, the user would see the identical consecutive three-dimensional images.

However, as shown in FIG. 2, the display time of the projected frames a1 to k1 are respectively Tₐ to Tₖ, and the display time of the projected frames a2 to k2 are respectively T_{c} to Tₘ. A frame delay ΔT exists between the first projected image IMG1 and the second projected image IMG2, and the frame delay ΔT is equal to ΔTₐ. Relatively, as shown in FIG. 3, the first projected image IMG1 falls behind the second projected image IMG2 in the time domain, the display time of the projected frames a1 to k1 are respectively T_{d} to Tₙ, and the display time of the projected frames a2 to k2 are respectively Tₐ to Tₖ. A frame delay ΔT exists between the first projected image IMG1 and the second projected image IMG2, and the frame delay ΔT is equal to −ΔT_{b}. Since the frame delay ΔT is not equal to zero, the first projected image IMG1 and the second projected image IMG2 are not synchronous.

In order to make the frame delay ΔT be equal to zero to synchronize the first projected image IMG1 with the second projected image IMG2 in the time domain, a conventional solution is to urge the user to buy two projectors having the same specification. However, this solution would increase the purchase cost and lower the user's desire to buy two identical projectors. More particularly, when the user has owned a projector, it is not a sensible way to urge the user to buy other two projectors.

Additionally, U.S. Pat. No. 6,456,339 discloses a projection system capable of composing a plurality of projected images of a plurality of projectors into an image, but unsynchronization of the projected images still occurs.

### SUMMARY OF THE INVENTION

The invention provides a decoder for decoding a three-dimensional video signal into first image data and second image data and adjusting an output time difference between an outputting time of the first image data and an outputting time of the second image data.

The invention provides a projection device, and a decoder of the projection device is capable of decoding a three-dimensional video signal into first image data and second image data and adjusting an output time difference between the outputting time of the first image data and the outputting time of the second image data.

The invention discloses an image processing method for processing a three-dimensional video signal. The image processing method is capable of decoding a three-dimensional video signal into first image data and second image data and adjusting an output time difference between the outputting time of the first image data and the outputting time of the second image data.

Other objects and advantages of the invention may be further illustrated by the technical features broadly embodied and described as follows.

In order to achieve one or a portion of or all of the objects or other objects, one embodiment of the invention is directed to a decoder including a decoding circuit and a buffer. The decoding circuit receives a three-dimensional video signal and a control signal and decodes the three-dimensional video signal to generate first image data and second image data. The buffer is coupled to the decoding circuit to temporarily store at least one of the first image data and the second image data. The decoding circuit adjusts an output time difference between the outputting time of the first image data and the outputting time of the second image data according to the control signal.

Another embodiment of the invention provides a projection device including a decoder and a projection module. The decoder has a decoding circuit and a buffer. The decoding circuit receives a three-dimensional video signal and a control signal and decodes the three-dimensional video signal to generate first image data and second image data. The buffer is coupled to the decoding circuit to temporarily store at least one of the first image data and the second image data. A projection module is coupled to the decoder to receive the first image data. The decoding circuit adjusts an output time difference between the outputting time of the first image data and the outputting time of the second image data according to the control signal.

The invention discloses an image processing method for processing a three-dimensional video signal. The image processing method has receiving the three-dimensional video signal and a control signal; decoding the three-dimensional video signal to generate first image data and second image data; temporarily storing at least one of the first image data and the second image data in a buffer; and adjusting an output time difference between an outputting time of the first image data and an outputting time of the second image data according to the control signal.

In light of the foregoing descriptions, the decoder of the embodiments of the invention decodes the three-dimensional video signal into the first image data and the second image data and adjusts the output time difference between the outputting time of the first image data and the outputting time of the second image data, such that the right eye and the left eye of the user would see synchronous three-dimensional images by using the decoder of the projection system.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings constituting a part of this specification are incorporated herein to provide a further understanding of the invention. Here, the drawings illustrate embodiments of the invention and, together with the description, serve to explain the principles of the invention.

FIG. 1 is a schematic diagram of a projection system according to the prior art.

FIG. 2 is a schematic diagram showing the first projected image of FIG. 1 antecedes the second projected image in the time domain.

FIG. 3 is a schematic diagram showing the first projected image of FIG. 1 falls behind the second projected image in the time domain.

FIG. 4 is a schematic diagram of a decoder coupled to a first projector and a second projector according to an embodiment of the invention.

FIG. 5 is a schematic diagram of the decoder, the first projector, the second projector and the screen of FIG. 4.

FIGS. 6-8 are timing diagrams of the first image data and the second image data when the output time difference ΔT₁ is zero, positive, and negative respectively.

FIG. 9 is a timing diagram of the first projected image and the second projected image when the value of the frame delay is equal to zero.

FIG. 10 is a flowchart of an image processing method according to an embodiment of the invention.

FIG. 11 is a schematic diagram of a first projector coupled to a second projector according to an embodiment of the invention.

FIG. 12 is a schematic diagram of the decoder, the first projector, the second projector and the screen of FIG. 11.

FIG. 13 is used to describe how to generate the control signal by using a sensor according to an embodiment of the invention.

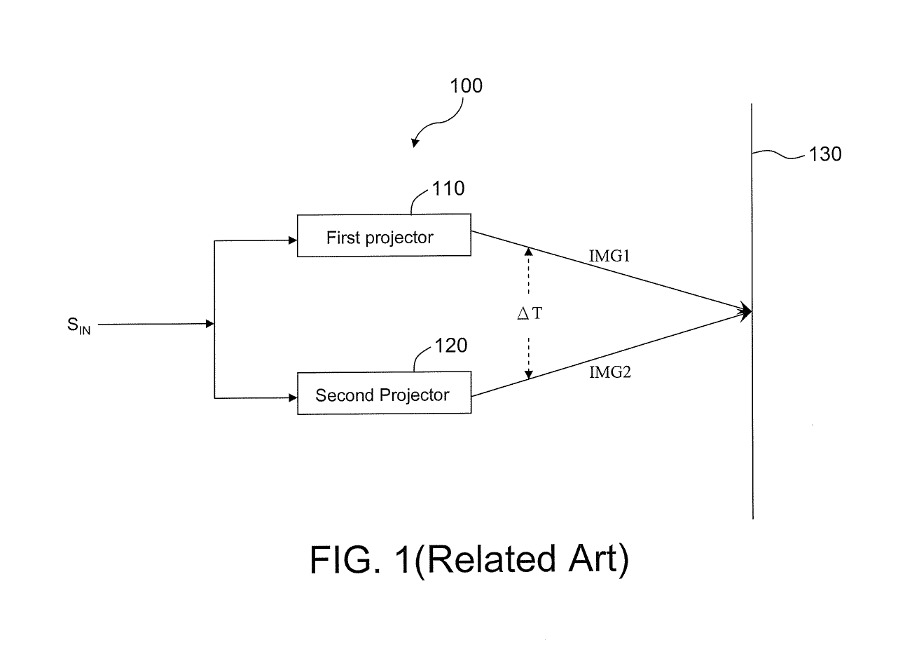

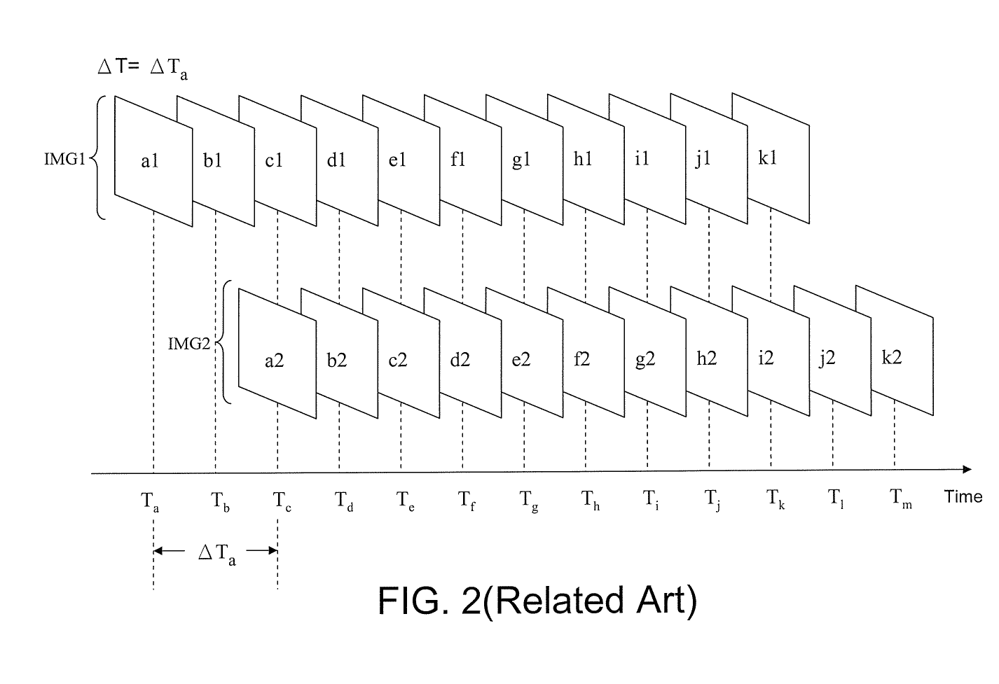

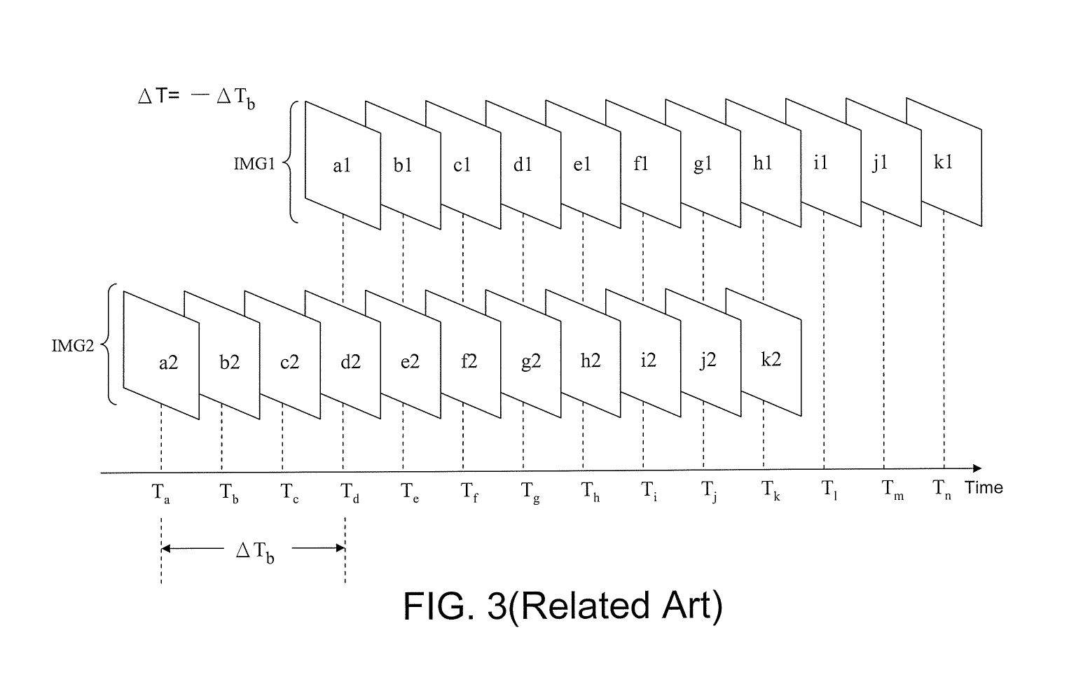

### DESCRIPTION OF EMBODIMENTS

It is to be understood that other embodiment may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

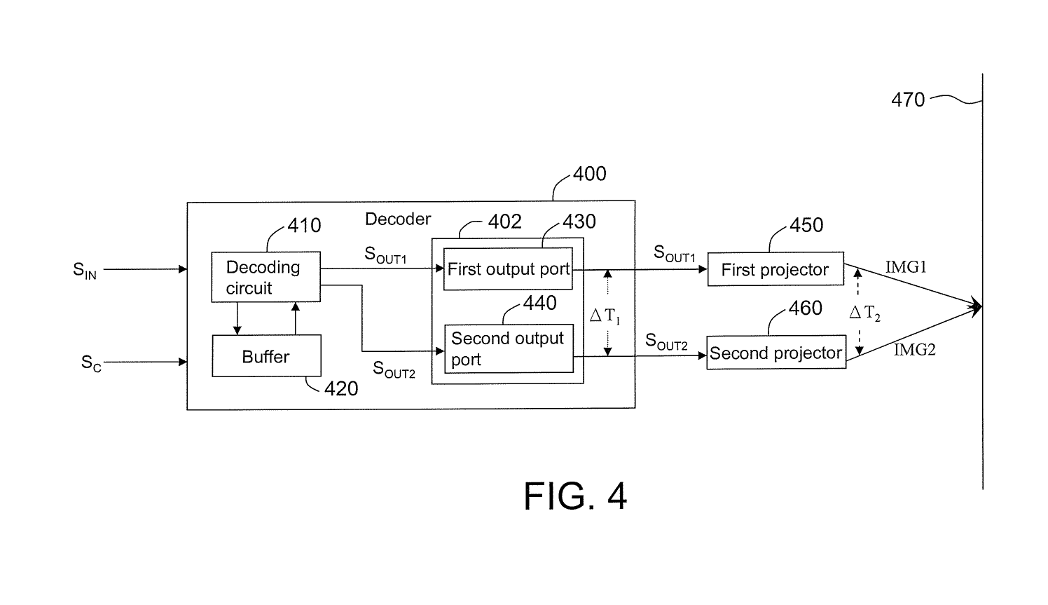

Please refer to FIG. 4. In the embodiment, the decoder 400 is coupled to the first projector 450 and the second projector 460, and the decoder 400 has a decoding circuit 410 and a buffer 420. The decoding circuit 410 is used to receive a three-dimensional video signal S_{IN} and a control signal S_{C} and decode the three-dimensional video signal S_{IN} to generate first image data S_{OUT1} and second image data S_{OUT2} The decoding rule of the three-dimensional video signal S_{IN} may be the decoding rule of High Definition Multimedia Interface (HDMI) 1.4 or the decoding rule of Field/Frame sequential, but the invention is not limited thereto.

The buffer 420 is coupled to the decoding circuit 410 to temporarily store at least one of the first image data S_{OUT1} and second image data S_{OUT2}. In other words, in different situations, the buffer 420 may store the first image data S_{OUT1} only, store the second image data S_{OUT2} only, or store both the first image data S_{OUT1} and the second image data S_{OUT2} at the same time. In the embodiment, the decoder 400 further comprises an output unit 402 coupled to the decoding circuit 410. The output unit 402 is composed of, for example, a first output port 430 and a second output port 440. The first output port 430 is used to output the first image data S_{OUT1}, and the second output port 440 is used to output the second image data S_{OUT2}.

In the embodiment, the decoding circuit 410 of decoder 400 may adjust an output time difference ΔT₁ between the first image data S_{OUT1} outputted from the first output port 430 and the second image data S_{OUT2} outputted from the second output port 440 according to the control signal S_{C}. In the embodiment, the user may use a user interface (not shown) to generate and transmit the control signal S_{C} to the decoder 400. The user interface may include a remote controller, a keyboard, buttons, a touch screen . . . and so forth.

In the embodiment, the first image data S_{OUT1} is transmitted to the first projector 450, such that the first projector 450 projects the first projected image IMG1 on the screen 470 according to the first image data S_{OUT1}. The second image data S_{OUT2} is transmitted to the second projector 460, such that the second projector 460 projects the second projected image IMG2 on the screen 470 according to the second image data S_{OUT2}. In the embodiment, the first projected image IMG1 and the second projected image IMG2 may be, for example, the images for the left eye and the right eye of the user respectively, but the invention is not limited thereto. In other embodiments, the first projected image IMG1 and the second projected image IMG2 may be the images for the right eye and the left eye of the user respectively.

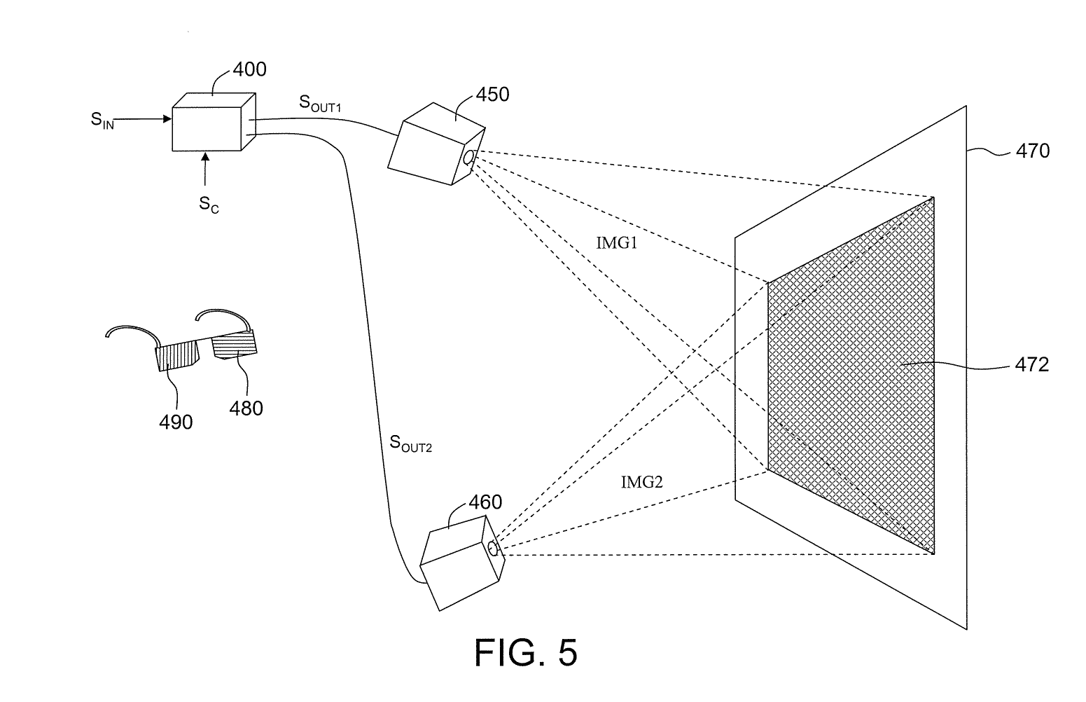

Please refer to FIG. 5 with reference of FIG. 4. In the embodiment, the projection areas, projection area 472 for example, of the first projected image IMG1 and the second projected image IMG2 on the screen 470 are substantially identical. In addition, the light of the first projected image IMG1 and the second projected image IMG2 have different polarization characteristics. The user may use a first polarizing unit 480 and a second polarizing unit 490, having different polarization characteristics, to see the first projected image IMG1 and the second projected IMG2 projected on the screen 470 by the first projector 450 and the second projector 460. In the embodiment, the first polarizing unit 480 is used to view the first projected image IMG1, and the second polarizing unit 490 is used to view the second projected image IMG2. In another embodiment, the first polarizing unit 480 is used to view the second projected image IMG2, and the second polarizing unit 490 is used to view the first projected image IMG1. Accordingly, the user may see a stereoscopic image by using the first polarizing unit 480 and the second polarizing unit 490.

As shown in FIG. 4, the frame delay between the first projected image IMG1 and the second projected image IMG2 is represented by ΔT₂. When the frame delay ΔT₂ is equal to zero, the first projected image IMG1 is synchronous with the second projected image IMG2. In the embodiment, the frame delay ΔT₂ may be adjusted by adjusting the output time difference ΔT₁. As described above, the decoding circuit 410 may adjust the output time difference ΔT₁ according to the control signal S_{C}. Therefore, the output time difference ΔT₁ and the frame delay ΔT₂ may be adjusted by transmitting the control signal S_{C} to the decoding circuit 410, and the first projected image IMG1 may be synchronous with the second projected image IMG2.

In the embodiment, when the decoder 400 would delay the outputting of the first image data S_{OUT1}, the decoding circuit 410 may temporarily store the first image data S_{OUT1} into the buffer 420 and then read the first image data S_{OUT1} from the buffer 420 according to the control signal S_{C}, such that the outputting of the first image data S_{OUT1} is delayed. In other words, after the decoding circuit 410 adjusts the time of reading the first image data S_{OUT1} from the buffer 420 according to the output time difference ΔT₁, the first projected image IMG1 would be synchronous with the second projected image IMG2. Relatively, when the decoder 400 would delay the outputting of the second image data S_{OUT2}, the decoding circuit 410 may temporarily store the second image data S_{OUT2} into the buffer 420 and then read the second image data S_{OUT2} from the buffer 420 according to the control signal S_{C}, such that the outputting of the second image data S_{OUT2} is delayed. In other words, after the decoding circuit 410 adjusts the time of reading the second image data S_{OUT2} from the buffer 420 according to the output time difference ΔT₁, the first projected image IMG1 would be synchronous with the second projected image IMG2.

Moreover, in other embodiments, the decoding circuit 410 may temporarily store the first image data S_{OUT1} and the second image data S_{OUT2} into the buffer 420 according to the control signal S_{C}. Afterwards, after the decoding circuit 410 adjusts the time of reading the first image data S_{OUT1} and the second image data S_{OUT2} from the buffer 420 according the output time difference ΔT₁, the first projected image IMG1 would be synchronous with the second projected image IMG2.

Furthermore, in other embodiments, the output unit 402 outputs the first image data S_{OUT1} and the second image data S_{OUT2} at different times according to the output time difference ΔT₁. After the output unit 402 outputs the first image data S_{OUT1} and the second image data S_{OUT2} at different times according to the output time difference ΔT₁, the first projected image IMG1 would be synchronous with the second projected image IMG2.

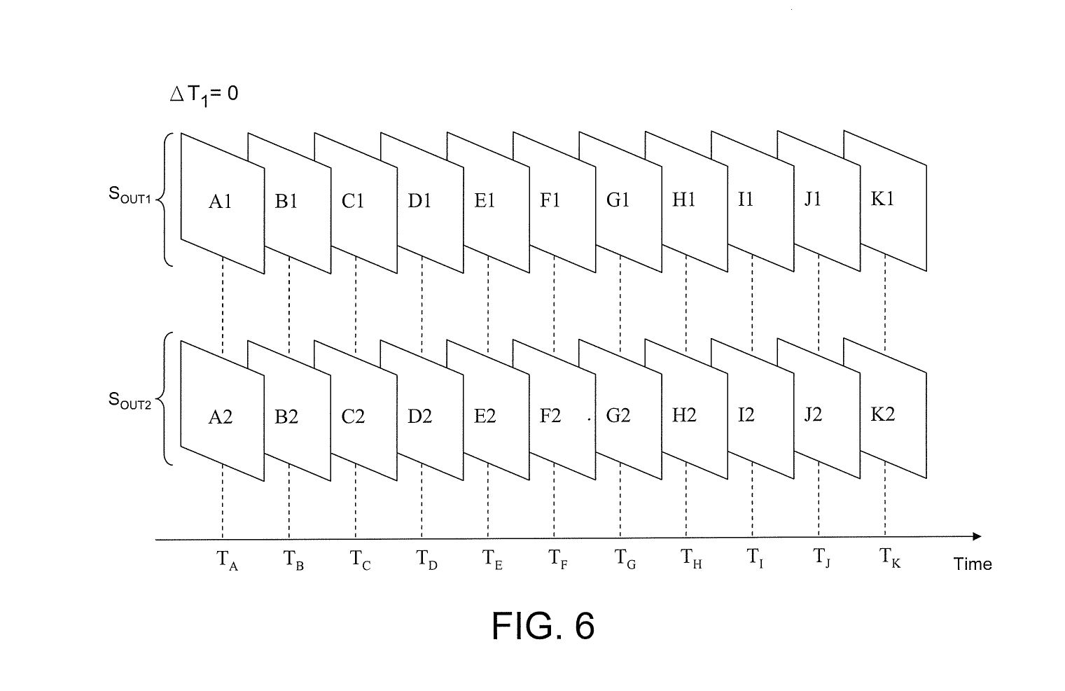

The value of the output time difference ΔT₁ in the embodiment may be used to represent the relationship between the first image data S_{OUT1} and the second image data S_{OUT2} in the time domain. Specifically, when the value of the output time difference ΔT₁ is equal to zero, it means that the first projected image IMG1 is synchronous with the second projected image IMG2. When the value of the output time difference ΔT₁ is positive, it means that that the first projected image IMG1 antecedes the second projected image IMG2. When the value of the output time difference ΔT₁ is negative, it means that that the first projected image IMG1 falls behind the second projected image IMG2. Please refer to FIG. 6 to FIG. 8. The first image data S_{OUT1} has a plurality of frames A1 to K1, and the second image data S_{OUT2} has a plurality of projected frames A2 to K2. The frames A1 to K1 and the frames A2 to K2 are sequentially illustrated in FIG. 6 to FIG. 8 from left to right, for example, according to the sequence of being output from the first output port 430 and the second output port 440 respectively.

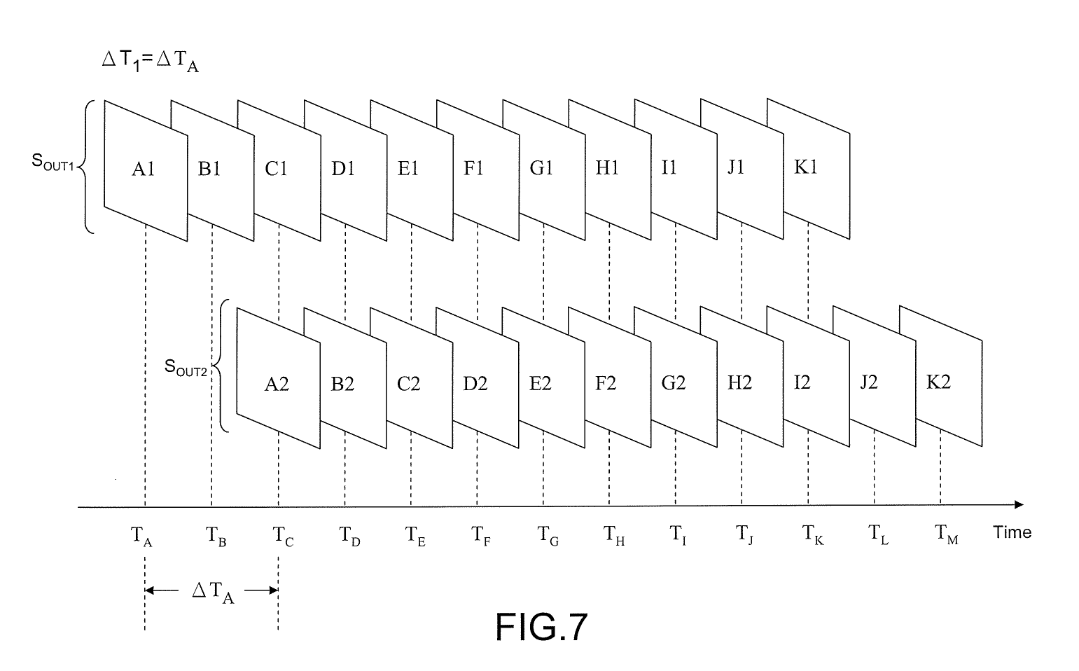

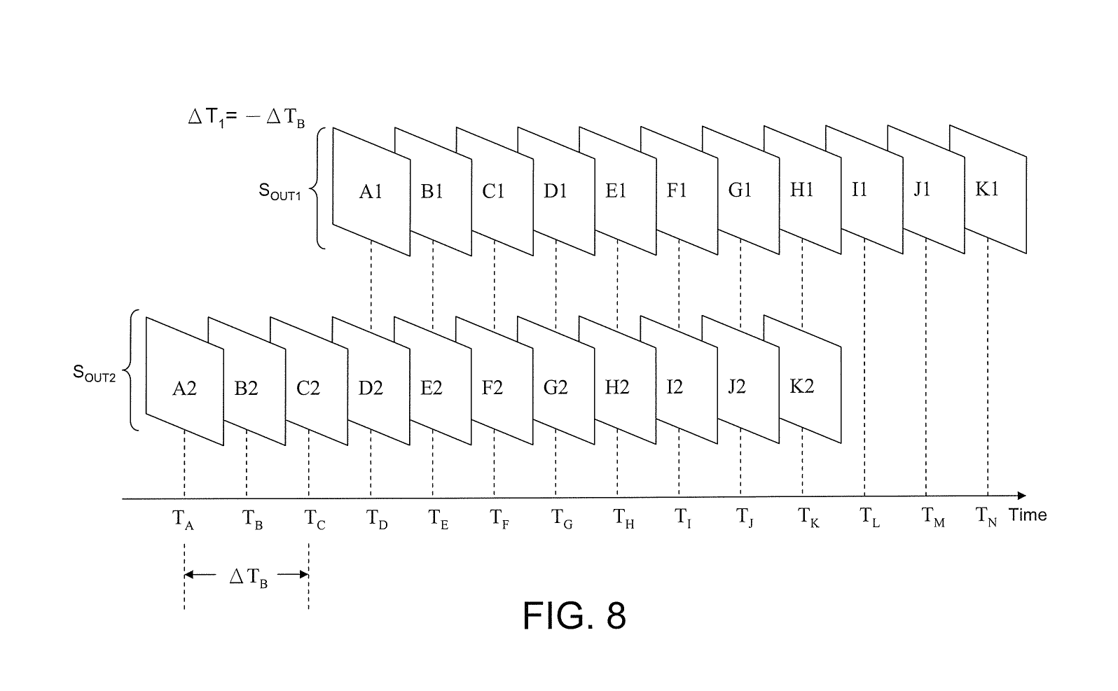

As described above, FIG. 6 represents the situation when the value of the output time difference ΔT₁ is equal to zero. The first image data S_{OUT1} is synchronous with the second image data S_{OUT2}, and the frames A1 to K1 and the frames A2 to K2 are respectively output from the first output port 430 and the second output port 440 at the time points T_{A} to T_{K}. FIG. 7 represents the situation when the value of the output time difference ΔT₁ is positive. The first image data S_{OUT1} antecedes the second image data S_{OUT2}. The frames A1 to K1 are respectively output from the first output port 430 at the time points T_{A} to T_{K}, and the frames A2 to K2 are respectively output from the second output port 440 at the time points T_{C} to T_{M}. It should be noted that the output time difference ΔT₁ is equal to two frame periods (i.e. ΔT_{A}) as shown in FIG. 7, but the invention is not limited thereto. A person skilled in this art should know that the output time difference ΔT₁ may be other values. In other words, the degree that the first image data S_{OUT1} antecedes the second image data S_{OUT2} may be adjusted according to the control signal S_{C}. FIG. 8 represents the situation when the value of the output time difference ΔT₁ is negative. The first image data S_{OUT1} falls behind the second image data S_{OUT2}. The frames A1 to K1 are respectively output from the first output port 430 at the time points T_{D} to T_{N}, and the frames A2 to K2 are respectively output from the second output port 440 at the time points T_{A} to T_{K}. The degree that the first image data S_{OUT1} falls behind the second image data S_{OUT2} may be also adjusted according to the control signal S_{C}.

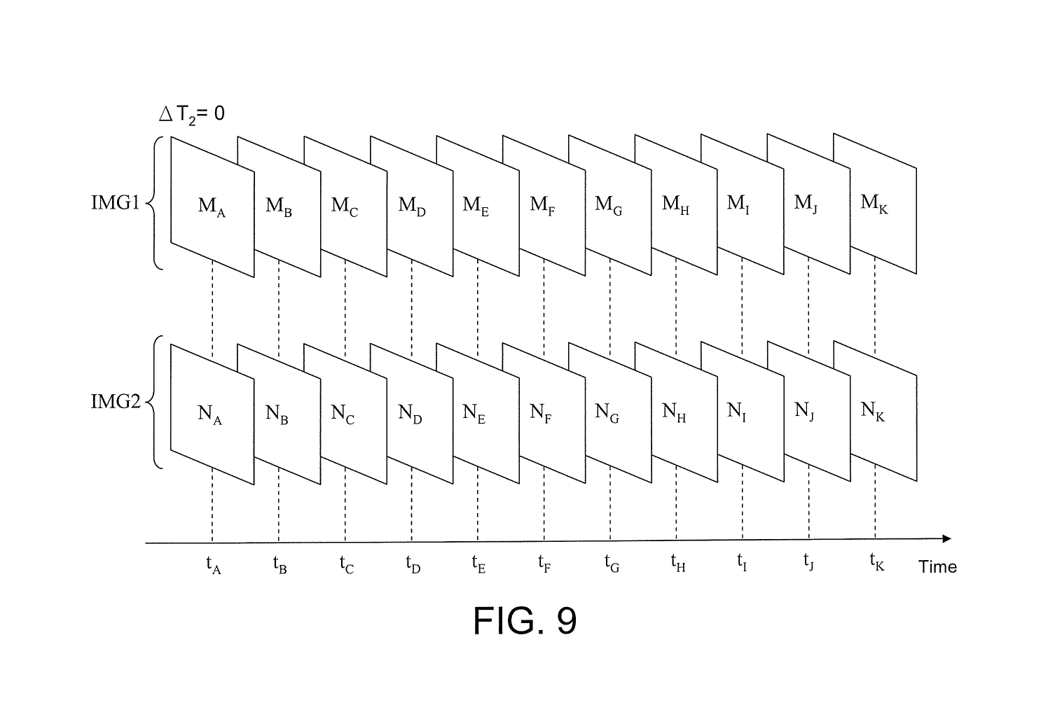

Please refer to FIG. 9. As described above, when the value of the frame delay ΔT₂ is equal to zero, it means that the first projected image IMG1 is synchronous with the second projected image IMG2. The first projected image IMG1 has a plurality of projected frames M_{A} to M_{K}, and the second projected image IMG2 has a plurality of projected frames N_{A} to N_{K}. The time points when the projected frames M_{A} to M_{K} and the projected frames N_{A} to N_{K} are projected on the screen are the time points t_{A} to t_{K}.

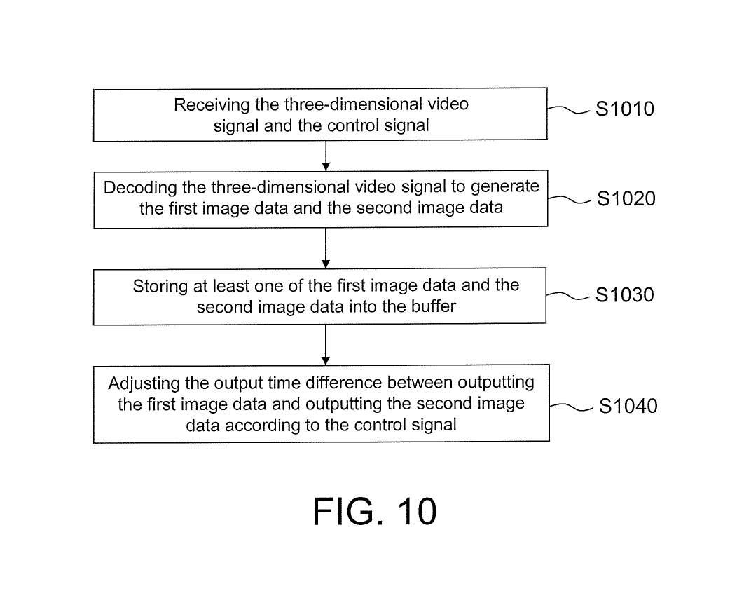

Please refer to the processing method in FIG. 10, and the image processing method is adapted to processing the three-dimensional video signal S_{IN}. Please refer to FIG. 4 and FIG. 10. Firstly, the decoder 400 receives the three-dimensional video signal S_{IN} and the control signal S_{C} (step S1010). Then, the decoder 400 decodes the three-dimensional video signal S_{IN} to generate the first image data S_{OUT1} and the second image data S_{OUT2} (step S1020). Then, the decoder 400 temporarily stores at least one of the first image data S_{OUT1} and the second image data S_{OUT2} in the buffer 420 (step S1030). Afterwards, the decoder 400 adjusts the output time difference ΔT₁ between outputting the first image data S_{OUT1} and outputting the second image data S_{OUT2} according to the control signal S_{C} (step S1040).

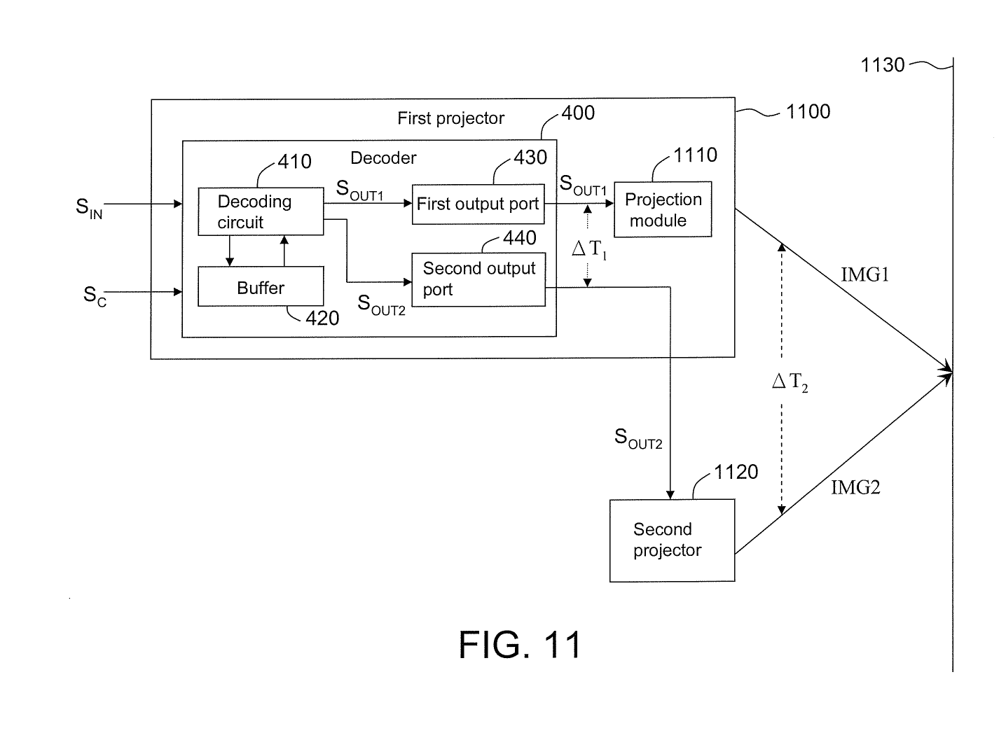

Please refer to FIG. 11. In the embodiment, the decoder 400 is positioned in the first projector 1100 (i.e. the decoder 400 is built in the projector 1100). The first projector 1100 further comprises a projection module 1100. The projection module 1100 is coupled to the first output port 430 to receive the first data image S_{OUT1} and to project the first projected image IMG1 on the screen 1130 according to the first image data S_{OUT1}. Moreover, the second output port 440 of the embodiment is coupled to the second projector 1120. The second output port 440 outputs the second image data S_{OUT2} to the second projector 1120, such that the second projector 1120 projects the second projected image IMG2 on the screen 1130 according to the second image data S_{OUT2}. The decoding circuit 410 makes the frame delay ΔT₂ be equal to zero or approach zero by adjusting the output time difference ΔT₁ to synchronize the first projected image IMG1 with the second projected image IMG2. Moreover, the decoding circuit may synchronize the first projected image IMG1 with the second projected image IMG2 by adjusting the time of reading at least one of the first image data S_{OUT1} and the second image data S_{OUT2} in the buffer 420 or by outputting the first image data S_{OUT1} and the second image data S_{OUT2} at different times through the output unit (e.g. the first output port 430 and the second output port 440). Therefore, the way to synchronize the first projected image IMG1 with the second projected image IMG2 is not limited in the in the invention.

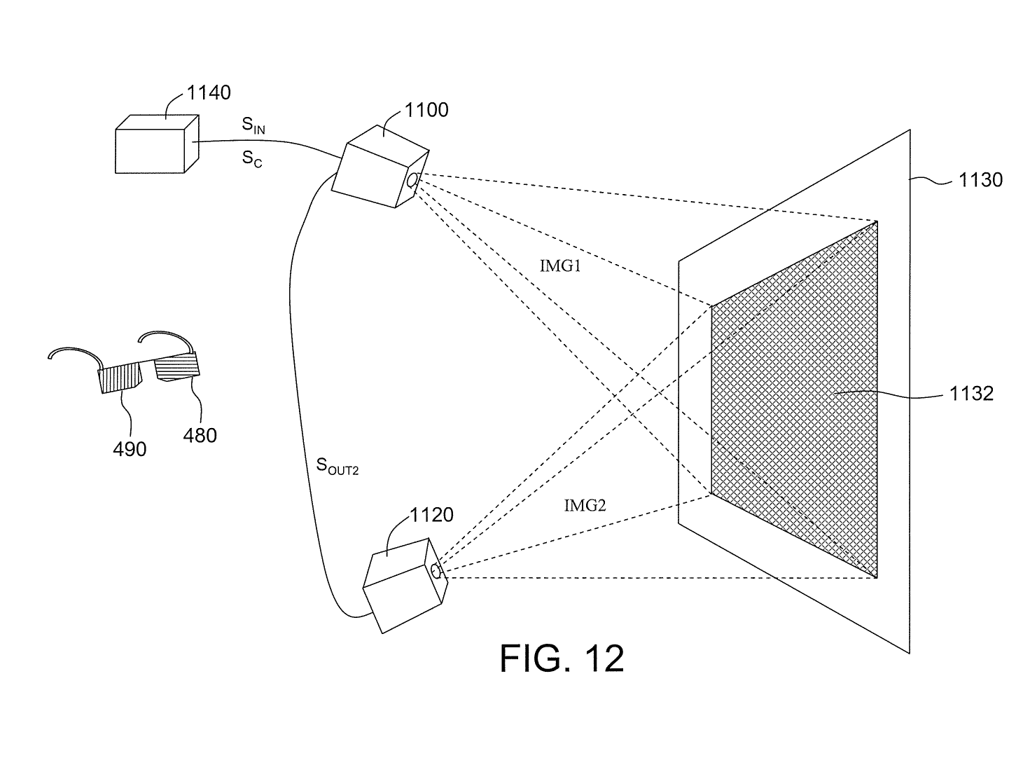

Furthermore, as shown in FIG. 12, the projection areas, projection area 1132 for example, of the first projected image IMG1 and the second projected image IMG2 on a screen 1130 are substantially identical. Additionally, in the embodiment, the first projector 1100 may receive the three-dimensional video signal S_{IN} and the control signal S_{C} from an exterior video device 1140. The exterior video device 1140 may be, for example, a DVD player, a set top box, a network receiver . . . and so forth.

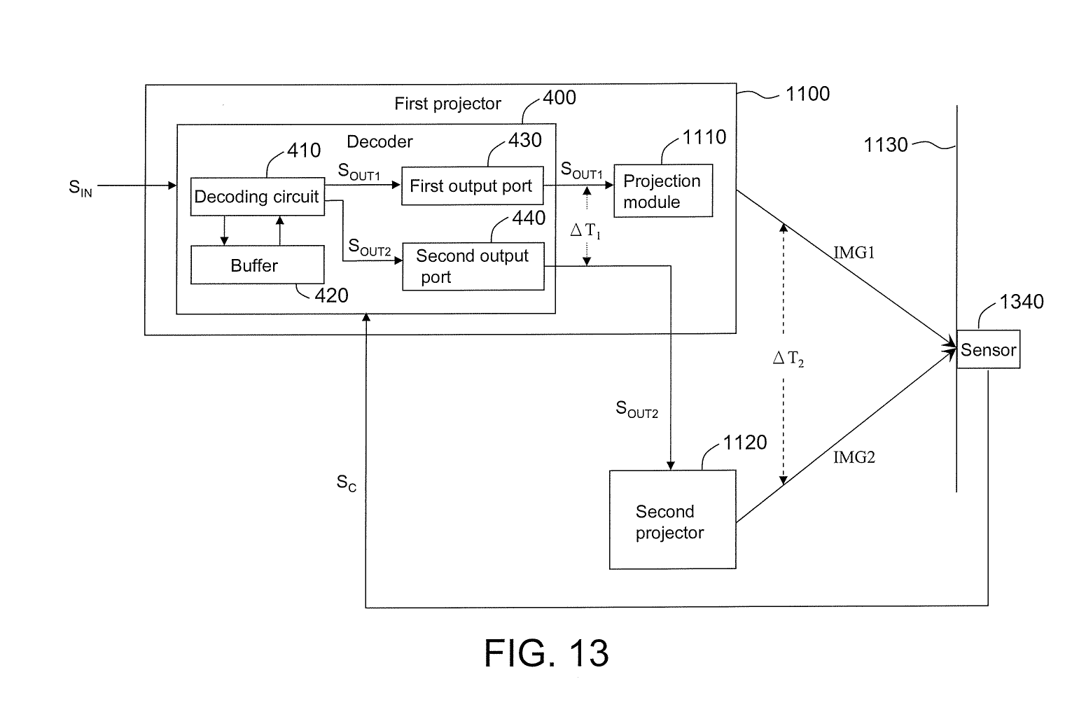

In the embodiment, the first projected image IMG1 and the second projected image IMG2 may be sensed by a sensor, such that the value of the frame delay ΔT₂ may be determined according to the result of sensing the first projected image IMG1 and the second projected image IMG2, and the control signal S_{C} may be generated accordingly. Please refer to FIG. 13. The sensor 1340 senses the first projected image IMG1 and the second projected image IMG2, such that the value of the frame delay ΔT, may be determined according to the result of sensing the first projected image IMG1 and the second projected image IMG2, and the control signal S_{C} may be generated accordingly. By feeding back the control signal S_{C} to the first projector 1100, the decoding circuit 410 automatically adjusts the output time difference ΔT₁ according to the feedback control signal S_{C}, such that the first projected image IMG1 is synchronous with the second projected image IMG2.

In conclusion, the embodiments of the invention include at least one of the following advantages or benefits. In the embodiments of the invention, the decoder is used in a projection device. The decoder decodes the three-dimensional video signal into the first image data and the second image data and adjusts the output time difference between outputting the first image data and outputting the second image data, such that the projection device may synchronously project the images for the left eye and the right eye of the user. Therefore, even the user uses two projectors having different hardware structures to project the left eye images and the right eye images, the left eye images and the right eye images seen by the user would be still synchronous since the output time difference between the first image data and the second image data may be adjusted. With the help of the decoder of the embodiments of the invention, two projectors having different specifications may output synchronous left eye images and right eye images. In other words, if the user has two different projectors, he/she may purchase the decoder of the embodiments of the invention to establish a three-dimensional projection system (i.e. the decoder is externally assembled with the two projectors). If the user has one projector, he/she may purchase another projector with any specification and the decoder of the embodiments of the invention to establish the three-dimensional projection system (i.e. the decoder is externally assembled with the two projectors). Moreover, with the help of the projector having the decoder of the embodiments of the invention (i.e. the decoder is built-in the projector), a projector with any specification and the projector having the built-in decoder may output synchronous left eye images and right eye images. For example, if the user has owned a projector, he/she may purchase the projector having the decoder of the embodiments of the invention to establish a three-dimensional projection system. Accordingly, the cost to establish a three-dimensional projection system may be decreased.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims. Moreover, these claims may refer to use “first”, “second”, etc. following with noun or element. Such terms should be understood as a nomenclature and should not be construed as giving the limitation on the number of the elements modified by such nomenclature unless specific number has been given.

What is claimed is:

1. A decoder, comprising:
a decoding circuit, for receiving a three-dimensional video signal and a control signal and decoding the three-dimensional video signal to generate a first image data and a second image data; and
a buffer, coupled to the decoding circuit, for temporarily storing at least one of the first image data and the second image data,
wherein the decoding circuit adjusts an output time difference between an outputting time of the first image data and an outputting time of the second image data according to the control signal.

2. The decoder as claimed in claim 1, wherein the decoding circuit writes the first image data into the buffer according to the control signal and reads the first image data from the buffer to result in the outputting time of the first image data being delayed relative to the outputting time of the second image data for the output time difference.

3. The decoder as claimed in claim 1, wherein the decoding circuit writes the second image data into the buffer according to the control signal and reads the second image data from the buffer to result in the outputting time of the second image data being delayed relative to the outputting time of the first image data for the output time difference.

4. The decoder as claimed in claim 1, wherein a first projection module receives the first image data and projects a first projected image according to the first image data, a second projection module receives the second image data and projects a second projected image according to the second image data, and the decoding circuit adjusts a time when reading at least one of the first image data and the second image data from the buffer according to the output time difference, such that the first projected image and the second projected image are synchronously projected on a screen.

5. The decoder as claimed in claim 4, wherein a projection area of the first projected image on the screen is substantially identical with a projection area of the second projected image on the screen.

6. The decoder as claimed in claim 4, wherein the first projected image is viewed through a first polarizing unit, the second projected image is viewed through a second polarizing unit, and the first polarizing unit and the second polarizing unit have different polarization characteristics.

7. The decoder as claimed in claim 1, further comprising:
an output unit, coupled to the decoding circuit, for outputting the first image data and the second image data, wherein the output unit outputs the first image data and the second image data at different times according to the output time difference.

8. The decoder as claimed in claim 7, wherein a first projection module receives the first image data and projects a first projected image according to the first image data, a second projection module receives the second image data and projects a second projected image according to the second image data, and after the output unit outputs the first image data and the second image data at different times according to the output time difference, the first projected image and the second projected image are synchronously projected on a screen.

9. The decoder as claimed in claim 8, wherein a projection area of the first projected image on the screen is substantially identical with a projection area of the second projected image on the screen.

10. The decoder as claimed in claim 8, wherein the first projected image is viewed through a first polarizing unit, the second projected image is viewed through a second polarizing unit, and the first polarizing unit and the second polarizing unit have different polarization characteristics.

11. A projection device, comprising:
a decoder, comprising:
a decoding circuit, for receiving a three-dimensional video signal and a control signal and decoding the three-dimensional video signal to generate first image data and second image data; and
a buffer, coupled to the decoding circuit, for temporarily storing at least one of the first image data and the second image data; and
a projection module, coupled to the decoder, for receiving the first image data;
wherein the decoding circuit adjusts an output time difference between an outputting time of the first image data and an outputting time of the second image data according to the control signal.

12. The projection device as claimed in claim 11, wherein the decoding circuit writes the first image data into the buffer according to the control signal and reads the first image data from the buffer to result in the outputting time of the first image data being delayed relative to the outputting time of the second image data for the output time difference.

13. The projection device as claimed in claim 11, wherein the decoding circuit writes the second image data into the buffer according to the control signal and reads the second image data from the buffer to result in the outputting time of the second image data being delayed relative to the outputting time of the first image data for the output time difference.

14. The projection device as claimed in claim 11, wherein the projection device projects a first projected image according to the first image data, another projection device receives the second image data and projects a second projected image according to the second image data, and the decoding circuit adjusts a time when reading at least one of the first image data and the second image data from the buffer according to the output time difference, such that the first projected image and the second projected image are synchronously projected on a screen.

15. The projection device as claimed in claim 14, wherein a projection area of the first projected image on the screen is substantially identical with a projection area of the second projected image on the screen.

16. The projection device as claimed in claim 14, wherein the first projected image is viewed through a first polarizing unit, the second projected image is viewed through a second polarizing unit, and the first polarizing unit and the second polarizing unit have different polarization characteristics.

17. The projection device as claimed in claim 11, wherein the decoder further comprises:
an output unit, coupled to the decoding circuit, for outputting the first image data and the second image data, wherein the output unit outputs the first image data and the second image data at different times according to the output time difference.

18. The projection device as claimed in claim 17, wherein the projection device projects a first projected image according to the first image data, another projection device receives the second image data and projects a second projected image according to the second image data, and after the output unit outputs the first image data and the second image data at different times according to the output time difference, the first projected image and the second projected image are synchronously projected on a screen.

19. The projection device as claimed in claim 18, wherein a projection area of the first projected image on the screen is substantially identical with a projection area of the second projected image on the screen.

20. The projection device as claimed in claim 18, wherein the first projected image is viewed through a first polarizing unit, the second projected image is viewed through a second polarizing unit, and the first polarizing unit and the second polarizing unit have different polarization characteristics.

21. An image processing method, adapted to processing a three-dimensional video signal, comprising:
receiving the three-dimensional video signal and a control signal;
decoding the three-dimensional video signal to generate first image data and second image data;
temporarily storing at least one of the first image data and the second image data in a buffer; and
adjusting an output time difference between an outputting time of the first image data and an outputting time of the second image data according to the control signal.

22. The image process method as claimed in claim 21, wherein the steps of temporarily storing at least one of the first image data and the second image data in the buffer and adjusting the output time difference between the outputting time of the first image data and the outputting time of the second image data according to the control signal comprise:
writing the first image data into the buffer according to the control signal and reading the first image data from the buffer to result in the outputting time of the first image data being delayed relative to the outputting time of the second image data for the output time difference.

23. The image process method as claimed in claim 21, wherein the steps of temporarily storing at least one of the first image data and the second image data in the buffer and adjusting the output time difference between outputting the first image data and outputting the second image data according to the control signal comprise:
writing the second image data into the buffer according to the control signal and reading the second image data from the buffer to result in the outputting time of the second image data being delayed relative to the outputting time of the first image data for the output time difference.

24. The image process method as claimed in claim 21, further comprising:
transmitting the first image data to a first projection module so that the first projection module projects a first projected image according to the first image data;
transmitting the second image data to a second projection module so that the second projection module projects a second projected image according to the second image data; and
adjusting a time when reading at least one of the first image data and the second image data from the buffer according to the output time difference, such that the first projected image is synchronous with the second projected image.

25. The image process method as claimed in claim 24, further comprising:
making a projection area of the first projected image on a screen be substantially identical with a projection area of the second projected image on the screen.

26. The image process method as claimed in claim 24, further comprising:
viewing the first projected image through a first polarizing unit; and
viewing the second projected image through a second polarizing unit, wherein the first polarizing unit and the second polarizing unit have different polarization characteristics.
